(19) United States
(12) Patent Application Publication
(10) Pub. No.: US 2003/0225817 A1
(43) Pub. Date: Dec. 4, 2003

(54) Concurrent execution of kernel work and non-kernel work in operating systems with single-threaded kernel

(76) Inventors: Prashanth Ishwar, Santa Clara, CA (US); Apurva Mehta, Cupertino, CA (US); Shiva Shenoy, San Jose, CA (US); Satinder Singh, Palo Alto, CA (US)

Correspondence Address: Wilson & Ham, PMB:348, 2530 Berryessa Road, San Jose, CA, 95132, US

(21) Appl. No.: 10/431,556

(22) Filed: May 7, 2003

Related U.S. Application Data
(60) Provisional application No. 60/386,081, filed on Jun. 4, 2002.

(51) Int. Cl. G06F 9/00

(52) U.S. Cl. 709/107

(57) ABSTRACT

A method of completing a kernel work concurrently with non-kernel work in a computer device having a single-threaded kernel is disclosed. The computer device completes kernel work within the context of a pacer process, which is a user process. In particular, atomic portions of the kernel work are executed in the context of the pacer process at which point nothing else is allowed to run. When an atomic portion of the kernel work has been executed, the pacer process temporarily relinquishes the processor of the computer device, thus suspending the execution of the kernel work and allowing execution of non-kernel work. Interrupts are also handled when execution of the kernel work is suspended. Once the kernel work has been completed, the pacer process goes into a “sleep” mode to await the invocation of another kernel work.

### CROSS-REFERENCE TO RELATED APPLICATION This application is entitled to the benefit of provisional Patent Application Serial No. 60/386,081, filed Jun. 4, 2002.

### FIELD OF THE INVENTION

The invention relates generally to computer operating systems, and more particularly, to a method of executing kernel work and non-kernel work concurrently in an operating system with single-threaded kernel.

### BACKGROUND OF THE INVENTION

Most modern operating systems achieve the illusion of concurrent processing by rapidly switching among different contexts of execution. That is, the operating system rapidly switches among multiple processes so that each process can use the central processing unit (CPU). The context of execution is also referred to as simply the “context,” “process,” “thread” or “task.” The act of switching context is also called “context switching.”

The operating system kernel, or simply, “the kernel” is the part of the operating system software that handles hardware resources, provides fundamental functionality, and provides fundamental programming interfaces to applications. When the computer is executing a user process, the operating system kernel is inactive. Likewise, when the computer is running the kernel, user processes are suspended.

When the computer is running one or more user processes, it will often context switch to allow other processes to run. However, in operating systems with a single-threaded kernel, when the kernel runs all other processes are stalled until the kernel operation is finished. Interrupts may be blocked when the kernel runs. Thus, if the kernel work requires a long time to complete, operations of the computer may be significantly affected.

The aforementioned problem is intensified when a single-threaded kernel operating system is used as the operating system of network devices such as switches and routers. A typical switch/router is a chassis-based system that includes a control module, which performs higher level management functions, and line cards, which provide the interface between the switch/router and other network devices (i.e., servers, workstations, other switch/routers, etc.) Certain switch/router operations are kernel operations, such as updating a Forwarding Information Base, that are time-consuming and resource intensive. When such kernel operations are carried out, the switch/router must wait for their completion before executing other processes. Even critical processes are blocked out. As a result, the performance of the switch/router may be significantly impacted.

Accordingly, what is needed is a method of performing kernel operation while allowing other processes to run in an operating system having a single-threaded kernel.

### SUMMARY OF THE INVENTION

The invention provides a method of executing kernel work concurrently with other processes in a computer device having a single-threaded kernel. In one embodiment, the computer device completes the kernel work within the context of a pacer process, which is a user process. In particular, atomic portions of the kernel work are executed in the context of the pacer process at which point nothing else is allowed to run. When an atomic portion of the kernel work has been executed, the pacer process temporarily relinquishes the processor of the computer device, thus suspending the execution of the kernel work and allowing execution of non-kernel work. Interrupts are also handled when execution of the kernel work is suspended. Once the kernel work has been completed, the pacer process goes into a “sleep” mode to await the invocation of new kernel work.

In one embodiment, kernel work can be initiated by a user process when the user process makes a system call. Kernel work can also be initiated by other means, such as a hardware interrupt or a network interrupt.

In one embodiment, the operating system includes a kernel work queue. When a process makes a system call that requires resource intensive kernel work, the operating system will determine whether the kernel work can be executed immediately. If so, the operating system will perform the kernel work without invoking the pacer process. If not, the operating system will put the kernel work in the kernel work queue, and the process making the system call will immediately return from the system call as if the kernel work has been done. The process will continue running until its time slice is over or until it sleeps because some resources it needs are unavailable. In the meantime, the invoked kernel work is executed piece by piece within the context of the pacer process.

Embodiments of the invention include the above and further include a computer program product for use in conjunction with a computer device that has an operating system with a single-threaded kernel. In one embodiment, the computer program product includes: (1) computer program codes to cause the computer device to execute single-threaded kernel work; (2) computer program codes to cause the computer device to intermittently suspend execution of single-threaded kernel work; and (3) computer program codes to cause the computer device to perform other processes when execution of the single-threaded kernel work is suspended. In another embodiment, the computer program product includes: (1) computer program codes to cause the computer device to initiate a single-threaded kernel work; (2) computer program codes to cause the computer device to suspend execution of the single-threaded kernel work to allow other processes to run when the single-threaded kernel work is suspended; and (3) computer program codes to cause the computer device to resume execution of the single-threaded kernel work after the non-kernel work has an opportunity to run.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a block diagram depicting a kernel space 10 and a user space 12 of a computer device that implements an embodiment of the invention.

FIG. 2 is a flow chart illustrating an embodiment of the invention.

FIG. 3 is a flow chart illustrating a process carried out according to an embodiment of the invention to determine whether kernel work should be executed immediately or queued.

FIG. 4 illustrates details of a computer system in which an embodiment invention can be implemented.

FIG. 5 illustrates details of a network node in which an embodiment the invention can be implemented.

### DETAILED DESCRIPTION OF THE INVENTION

The embodiments of the invention described are implemented in a computing platform based on a computer operating system that has a single-threaded kernel. One such operating system is NetBSD, which is available as open source directly over the Internet. It will also be understood that NetBSD examples are shown for illustrative purposes only. The inventive concepts described herein can be adapted to any operating system with a single-threaded kernel such as Linux.

As is known by those skilled in the art, the operating system kernel, or simply, “the kernel” refers to the software of a computer device that handles hardware resources, controls processing, and communicates with external devices. In addition, the kernel provides kernel services to user programs. Programs access these services by making system calls. System calls look like procedure calls when they appear in a program, but transfer to operating system routines when invoked at run-time. Taken as a set, the system calls establish a well-defined boundary between the running program and the operating system. The term “kernel work” is used in the present disclosure to refer to an operating system routine intended to be carried out by the operating system to achieve a kernel function such as handling hardware resources, controlling processing, communicating with external devices, and providing kernel services to user programs. Kernel work herein also refers to any other “atomic” activities of the operating system. Atomic activities refer to operations of the computer device at which context switching is not allowed to occur.

As is known by those skilled in the art, when a single-threaded kernel runs, all processes are stalled, and all interrupts may be blocked. Kernel work of a single-threaded kernel is considered “atomic.” That is, context switching is not allowed to occur when a single-threaded kernel runs. This is a problem for prior art single-threaded computing platforms if the kernel work takes many processor cycles because, when an operating system routine takes a long time to finish, other processes will be stalled for a long time. Unlike single-threaded computing platforms of the prior art, the invention performs resource intensive kernel work in the context of a user process. When kernel work is performed in the context of a user process, context switching can occur if the process explicitly relinquishes execution (e.g., sleeps), thus allowing other processes (including user processes and other kernel operations) to run. In addition, interrupts are not blocked when the kernel work is executed in the context of the user process.

According to the invention, the operating system includes a Kernel Work Queue. When resource intensive kernel work is invoked, and when the computer device does not have sufficient resource to execute the kernel work immediately, the operating system stores information related to the kernel work in the Kernel Work Queue. When resources become available, the operating system retrieves the kernel work information from the Kernel Work Queue and performs the kernel work accordingly.

According to the invention, the user process under the context of which the kernel runs is referred to as a Pacer process. The Pacer process is normally asleep. Once awakened, the Pacer process accesses the Kernel Work Queue and begins execution of the kernel work identified by the Kernel Work Queue. However, the Pacer process does not necessarily execute the entire kernel work “atomically.” Rather, once a predetermined number of work units of the kernel work have been performed, the Pacer process temporarily relinquishes the processor, thus allowing other processes to run and allowing interrupts to be handled. Note that, during the execution of the predetermined number of work units, context switching is not allowed. It is only after the completion of the predetermined number of work units that context switching can occur. In other words, context switching occurs after atomic portions of the kernel work have been performed.

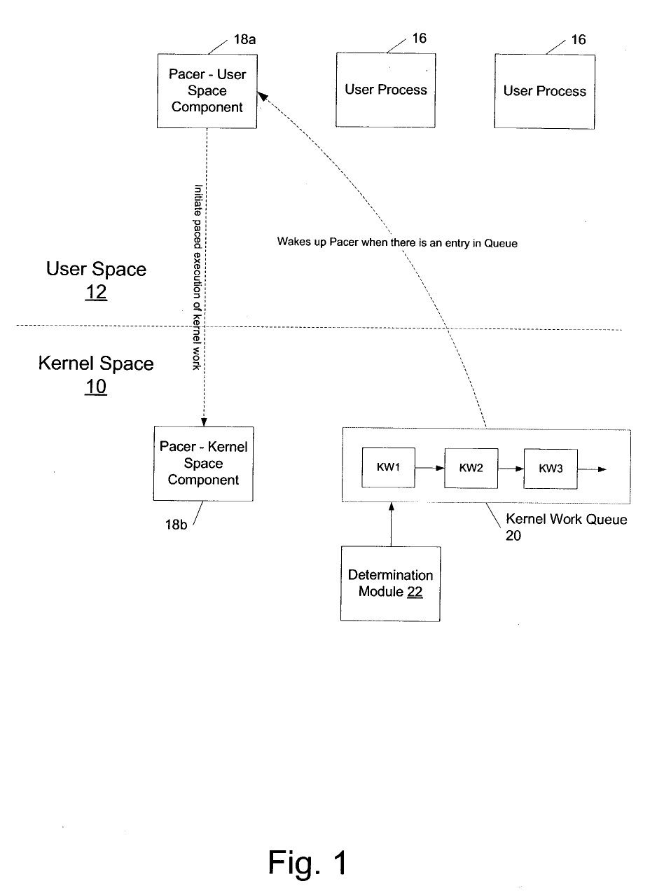

In order to help the reader visualize the invention, a block diagram depicting a kernel space 10 and a user space 12 of a computer device that implements an embodiment of the invention is shown in FIG. 1. As depicted, multiple user processes 16 are executed contemporaneously by the processor of the computer device. A Pacer process is also shown. Note that the Pacer process has two components: a user space component 18a and a kernel space component 18b. Also shown are a Kernel Work Queue 20 and a Determination Module 22. Operations of the Determination Module 22, which determines when a kernel work should be executed immediately or queued, are described further below.

In one embodiment, a select system call is made by the Pacer user space component 18a when the Pacer process is initialized. The select system call maps to a specific “select” routine of the Pacer kernel space component 18b. When this “select” routine is invoked, the Pacer kernel space component 18b checks the Kernel Work Queue 20 to determine if there is any work to be done. If there is, the select system call returns to the Pacer user space component 18a with the information that there is work to be done.

If there is no work to be done, then the “select” routine of the Pacer kernel space component 18b puts the Pacer process in the Sleep List. As is well known in the art, a process is asleep or suspended when the scheduler of the operating system puts the process on a Sleep List or Sleep Queue. When kernel work is queued, a signal is sent to the Pacer kernel space component 18b, which effectively puts the pacer into a Ready or Runable List (not shown). When this occurs, the Pacer process is said to have “woken up,” and the select system call returns to the Pacer user space component 18a with the information that there is work to be done.

The return of the select system call causes the Pacer user space component 18a to make a write system call. The write system call maps to a specific “write” routine of the Pacer kernel space component 18b. When this “write” routine is invoked, the Pacer kernel space component 18b access the Kernel Work Queue 20 and begins executing a predetermined number of kernel work units. The Pacer kernel space component 18b temporarily relinquishes the processor after a predetermined number of kernel work units have been completed.

If runable processes are pending when the Pacer process temporarily relinquishes the processor, they will have an opportunity to be executed. If interrupts are pending, they will have an opportunity to be handled. Note that, in one embodiment, the Pacer process is not asleep after it has temporarily relinquished the processor. Rather, the scheduler of the operating system re-orders its Ready List and gives other processes a higher priority for execution. Thus, once all the other processes on the Ready List have a chance to run, execution of the Pacer process will resume. In one embodiment, the system call yield is used by the kernel space component 18b to temporarily relinquish the processor after a predetermined number of kernel work units have been completed. The system call yield is a standard system call of the NetBSD operating system.

The system call yield is used in a preferred embodiment of the invention because, when the system call yield is invoked, an entire snapshot of all necessary data for the process to resume (e.g., program counters, registers) is saved. Thus, when the Pacer process resumes the execution of the kernel work, the Pacer process will resume from the exact point before the yield system call is invoked.

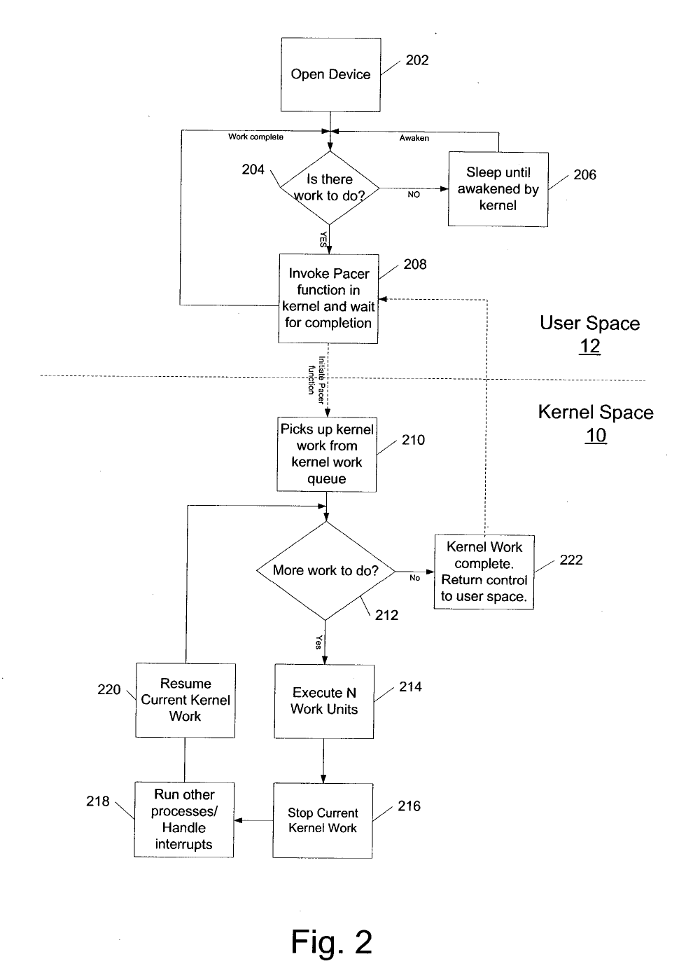

FIG. 2 is a flow chart illustrating an embodiment of the invention. Note that FIG. 2 is divided into a User Space 12 section and a Kernel Space 10 section. Some of the steps of the flow chart are carried out in the User Space 12 and some of the steps are carried out in the Kernel Space 10. Specifically, in the illustrated embodiment, steps 202-208 are carried out by the User Space Component 18a of FIG. 1. Steps 210-216 and 220-222 are carried out by the Kernel Space Component 18b of FIG. 1.

Referring now to FIG. 2, at step 202, the User Space Component 18a makes a system call open on a Pacer device. A device identifier will return from this system call. In one embodiment, the device identifier corresponds to the Kernel Space Component 18b.

At decision point 204, the User Space Component 18a determines whether there is any kernel work to do. If, there is no kernel work to be done, at step 206, the User Space Component 18a will remain in a sleep mode until woken up by the operating system. If there is kernel work to be done, the User Space Component 18a will be awakened by the operating system. The awakened User Space Component 18a will invoke the Kernel Space Component 18b at step 208. When the Kernel Space Component 18b is done, the User Space Component 18a will enter sleep mode and wait for the next kernel work.

In one embodiment, steps 204-208 are implemented programmatically with two system calls select and write in a tight loop. The system call select is called with the device identifier obtained from step 202 such that, when there is kernel work for the Kernel Space Component 18b, the system call select will return. When the system call select returns, the system call write is invoked with the device identifier to signal the Kernel Space Component 18b to perform the write function. In this embodiment the Kernel Space Component 18b is programmed such that it does not perform a standard “write” operation in response to the system call write. Rather, the Kernel Space Component 18b is programmed such that it will carry out steps 210-222 in response to the system call write.

At step 210, in response to the system call write from User Space Component 18a, the Kernel Space Component 18b retrieves kernel work information from the Kernel Work Queue 20. In one embodiment the Kernel Space Component 18b retrieves information such as:

Type of kernel work (e.g. modify a hardware table).

Number of units of kernel work to do before yielding control.

Parameters of the kernel (e.g., name of the hardware table, index, etc.)

At decision point 212, the Kernel Space Component 18b determines whether the kernel work associated with the retrieved information has been completed. In one embodiment, because the kernel work information may have been stored in the Kernel Work Queue 20 for some time, the current kernel work may have been canceled by other processes. If the current kernel work has been completed or has been canceled, the Kernel Space Component 18b returns the control to the User Space Component 18a (step 222).

If there is more work to do, at step 214, the Kernel Space Component 18b executes a predetermined number (N) of units of the kernel work. For example, if the current kernel work is to update 5000 entries of a hardware table, the Kernel Space Component 18b may update only 100 entries. Note that the kernel work performed at step 214 is atomic. That is, context switching cannot occur during step 214.

Then, at step 216, after the predetermined units of the kernel work have been done, the Kernel Space Component 18b temporarily relinquishes the processor and halts the execution of the kernel work. In this step, the Pacer process is suspended. At step 218, when the Pacer process is suspended, the operating system allows other processes to run and allows the kernel to handle any pending interrupts. At step 220, after the Kernel Space Component 18b resumes the current kernel work. Steps 212 through 220 are repeated until all the queued kernel work has been completed.

In one embodiment, steps 216-220 are accomplished when the Kernel Space Component 18b invokes the system call yield. As discussed above, the system call yield temporarily relinquishes the processor, allows other processes that are ready to run, allows the kernel to handle any pending interrupts, and causes the Pacer process to resume from the exact point where it left off.

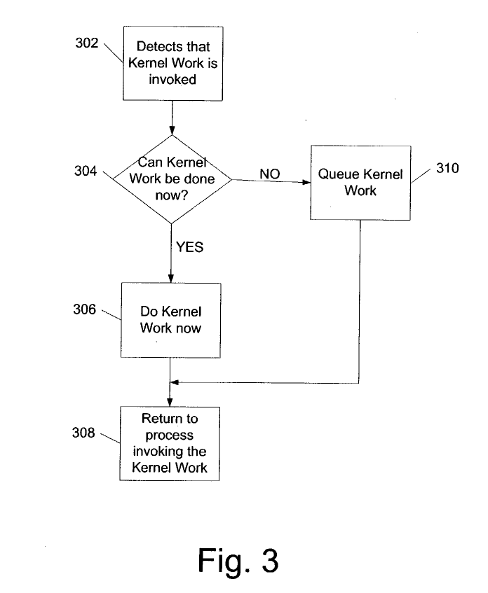

FIG. 3 is a flow chart illustrating a process carried out by the operating system of the invention to determine whether kernel work should be immediately executed or queued. In one embodiment, the steps of FIG. 3 are carried out by the Determination Module 22 of FIG. 1. As shown, at step 302, the Determination Module 22 detects that kernel work is invoked. As is well known in the art, kernel work can be invoked by a user process when a user process makes a system call. Kernel work can also be invoked by a non-user process, such as a hardware interrupt (or network interrupt), or a kernel timer going off, etc.

At decision point 304, the Determination Module 22 examines the type of the kernel work invoked, the amount of work required, as well as the currently available computation resources to determine whether the kernel work can be immediately executed. In one embodiment, the Determination Module 22 further examines whether there is any queued kernel work that may create a conflict. For example, if a kernel work for updating a certain hardware table of the computer device is queued already, another kernel work that requires accessing the same hardware table may need to be queued, even if there are sufficient resources to execute the access operation immediately.

In one embodiment, the Determination Module 22 may allow a later invoked kernel work to be executed before or during the execution of an earlier invoked but more resource intensive kernel work. The later invoked kernel work can be executed even if there is a conflict. As an example, suppose the earlier invoked kernel work is for updating many entries of a hardware table, and suppose the later invoked kernel work is for removing a few of the entries of the same hardware table. In this example, the Determination Module 22 may determine that the later invoked kernel work should not be queued, allowing the later invoked kernel work to execute when the earlier invoked kernel work is suspended. In that case, the Determination Module 22 will indicate to the Pacer process that certain deleted entries should be skipped when the earlier invoked kernel work resumes execution.

With reference still to FIG. 3, if it is determined that the kernel work can be performed immediately, the kernel work will be executed (step 306). In this step, the kernel work is executed atomically to completion. Then, after the kernel work is completed, the operating system will indicate to the process invoking the kernel work that the kernel work has been finished by returning the system call.

If it is determined that the kernel work cannot be performed immediately, the kernel work is queued (step 310). In one embodiment, information regarding the queued kernel work is stored in the Kernel Work Queue 20. Then, the operating system will indicate to the process invoking the kernel work that the kernel work has been finished by returning the system call, even though the kernel work is not completed.

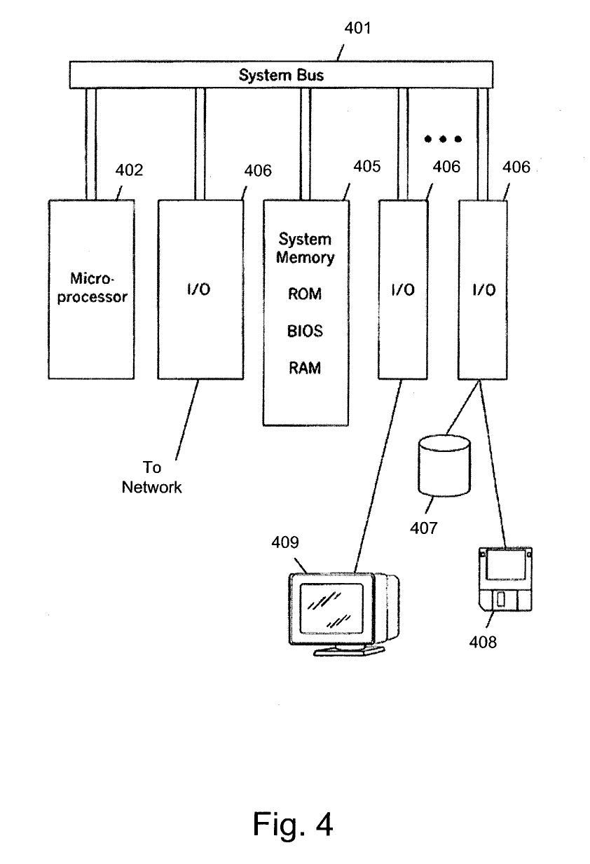

The invention can be implemented through computer program code operating on a programmable computer system or instruction execution system such as a personal computer or workstation, or other microprocessor-based platform. FIG. 4 illustrates details of a computer system that is implementing the invention. System bus 401 interconnects the major components. The system is controlled by microprocessor 402, which serves as the central processing unit (CPU) for the system. System memory 405 is typically divided into multiple types of memory or memory areas such as read-only memory (ROM), random-access memory (RAM) and others. The system memory may also contain a basic input/output system (BIOS). A plurality of general input/output (I/O) adapters or devices 406 are present. Only three are shown for clarity. These connect to various devices including a fixed disk drive 407 a diskette drive 408, network 410, and a display 409. Computer program code instructions for implementing the functions of the invention are stored on the fixed disk 407. When the system is operating, the instructions are partially loaded into memory 405 and executed by microprocessor 402. Optionally, one of the I/O devices is a network adapter or modem for connection to a network, which may be the Internet. It should be noted that the system of FIG. 4 is meant as an illustrative example only. Numerous types of general-purpose computer systems are available and can be used.

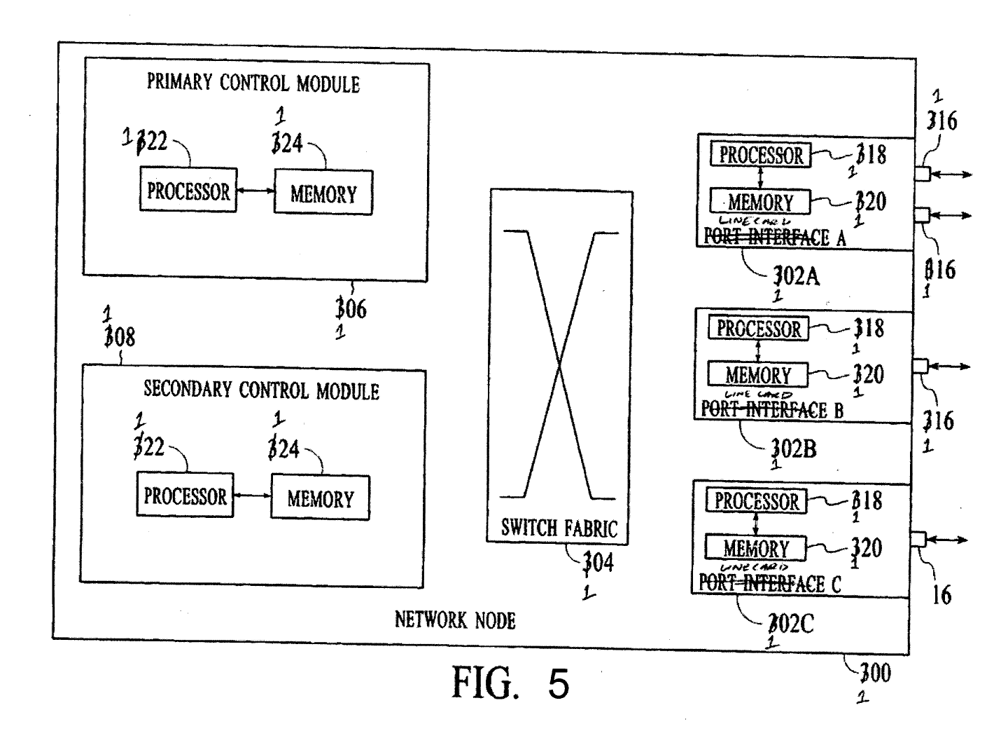

The invention can be implemented through computer program code operating on a network node such as a switch or router. FIG. 5 illustrates details of a network node 100 that is implementing the invention. The network device 100 includes a primary control module 106, a secondary control module 108, a switch fabric 104, and three line cards 102A, 102B, and 102C (line cards A, B, and C). The switch fabric 104 provides datapaths between input ports and output ports of the network node 100 and may include, for example, shared memory, shared bus, and crosspoint matrices.

The primary and secondary control modules 106 and 108 support various switch/router and control functions, such as network management functions and protocol implementation functions. The control modules 106 and 108 each include a processor 122 and memory 124 for carrying out the various functions. The processor 122 may include a multifunction microprocessor (e.g., an Intel i386 processor) and/or an application specific processor that is operationally connected to the memory. The memory 124 may include electrically erasable programmable read-only memory (EEPROM) or flash ROM for storing operational code and dynamic random access memory (DRAM) for buffering traffic and storing data structures, such as forwarding information.

The line cards 102A, 102B, and 102C each include at least one port 116, a processor 118, and memory 120. The processor 118 may be a multifunction processor and/or an application specific processor that is operationally connected to the memory 120, which can include a RAM or a Content Addressable Memory (CAM). Each of the processors 118 performs and supports various switch/router functions.

With reference still to FIG. 5, the processors 118 and 122 each run a separate instance of an operating system. In one embodiment, each processor runs a separate instance of the NetBSD operating system. According to the invention, the Pacer process can be implemented in the line cards or the control modules. In this way, processes are not necessarily stalled for a long time when resource intensive kernel work is currently being executed.

Elements of the invention may be embodied in hardware and/or software as a computer program code (including firmware, resident software, microcode, etc.). Furthermore, the invention may take the form of a computer program product on a computer-usable or computer-readable storage medium having computer-usable or computer-readable program code embodied in the medium for use by or in connection with an instruction execution system such as those shown in FIGS. 4 and 5. A computer-usable or computer-readable medium may be any medium that can contain, store, communicate, or transport the program for use by or in connection with an instruction execution system. The computer-usable or computer-readable medium can be, for example, an electronic, magnetic, optical, electromagnetic, infrared, or semiconductor system. The medium may also be simply a stream of information being retrieved when the computer program product is “downloaded” through a network such as the Internet. Note that the computer-usable or computer-readable medium could even be paper or another suitable medium upon which a program is printed.

Finally, although specific embodiments of the invention have been described and illustrated, the invention is not to be limited to the specific forms or arrangements of parts as described and illustrated herein. For instance, it should also be understood that throughout this disclosure, where a software process or method is shown or described, the steps of the method may be performed in any order or simultaneously, unless it is clear from the context that one step depends on another being performed first.

What is claimed is:

1. A method of performing single-threaded kernel work in an operating system of a computer device, the method comprising:
intermittently suspending execution of a single-threaded kernel work; and
executing at least part of one or more processes when execution of the single-threaded kernel work is suspended.

2. The method of claim 1, further comprising handling one or more interrupts when execution of the single-threaded kernel work is suspended.

3. The method of claim 1, further comprising providing a single-threaded kernel work queue for storing information corresponding to a plurality of queued single-threaded kernel works.

4. The method of claim 1, further comprising providing a user process under a context of which the single-threaded kernel work is performed.

5. The method of claim 1, wherein the intermittently suspending step comprises:
executing a portion of the single-threaded kernel work in a context of a user process, and
temporarily suspending the user process after execution of the portion.

6. The method of claim 5, further comprising suspending the pacer process after execution of the single-threaded kernel work.

7. The method of claim 1, wherein the intermittently suspending step comprises:
temporarily relinquishing a processor unit of the computer device; and
resuming execution of the single-threaded kernel work after at least one of the one or more processes has an opportunity to run.

8. The method of claim 1, wherein the one or more processes comprise one or more user processes.

9. A method of performing single-threaded kernel works in an operating system that has a single-threaded kernel, the method comprising:
initiating a single-threaded kernel work;
suspending execution of the single-threaded kernel work to allow one or more processes to run when the single-threaded kernel work is suspended; and
resuming execution of the single-threaded kernel work after the one or more processes have the opportunity to run.

10. The method of claim 9, further comprising repeating the suspending step and the resuming step until the single-threaded kernel work is complete.

11. The method of claim 9, further comprising:
determining whether a next single-threaded kernel work is resource intensive;
storing information corresponding to the next single-threaded kernel work in a single-threaded kernel work queue if it is determined that the next single-threaded kernel work is resource intensive.

12. The method of claim 1, further comprising executing the next single-threaded kernel work atomically provided the next single-threaded kernel work is not resource intensive.

13. The method of claim 9, further comprising handling one or more interrupts when the single-threaded kernel work is suspended.

14. The method of claim 9, wherein the one or more processes comprise one or more user processes.

15. A computer program product for use in conjunction with a computer device that has an operating system with a single-threaded kernel, the computer program product comprising a computer usable medium and a computer program mechanism embodied therein that causes the computer device to perform single-threaded kernel work concurrently with processes, the computer program product having:
computer program codes to cause the computer device to intermittently suspend execution of single-threaded kernel work; and
computer program codes to cause the computer device to execute at least part of one or more processes when execution of the single-threaded kernel work is suspended.

16. The computer program product of claim 15, further comprising computer program codes to cause the computer device to handle one or more interrupts when execution of the single-threaded kernel work is suspended.

17. The computer program product of claim 15, further comprising computer program codes to cause the computer device to provide a single-threaded kernel work queue for storing information corresponding to a plurality of queued kernel works.

18. The computer program product of claim 15, further comprising computer program codes to cause the computer device to provide a user process under a context of which the single-threaded kernel work is executed.

19. The computer program product of claim 15, wherein the computer program codes to cause the computer device to intermittently suspend execution comprises:
computer program codes to cause the computer device to execute a portion of the single-threaded kernel work in a context of a user process, and
computer program codes to cause the computer device to temporarily suspend the user process after execution of the portion.

20. The computer program product of claim 19, further comprising computer program codes to cause the computer device to suspend the user process after execution of the single-threaded kernel work.

21. The computer program product of claim 15, wherein the computer program codes to cause the computer device to intermittently suspend execution comprises:
computer program codes to cause the computer device to temporarily relinquish a processor of the computer device; and
computer program codes to cause the computer device to resume execution of the single-threaded kernel work after at least one of the one or more processes has an opportunity to run.

22. The computer program product of claim 15, wherein the one or more processes comprise one or more user processes.

23. A computer program product for use in conjunction with a computer device that has an operating system with a single-threaded kernel, the computer program product comprising a computer usable medium and a computer program mechanism embodied therein that causes the computer device to perform single-threaded kernel work concurrently with processes, the computer program product having:
computer program codes to cause the computer device to initiate a single-threaded kernel work;
computer program codes to cause the computer device to suspend execution of the single-threaded kernel work to allow one or more processes to run when the single-threaded kernel work is suspended; and
computer program codes to cause the computer device to resume execution of the single-threaded kernel work after the one or more processes have the opportunity to run.

24. The computer program product of claim 23, further comprising computer program codes to cause the computer device to repeatedly suspend and resume execution of the single-threaded kernel work until the single-threaded kernel work is complete.

25. The computer program product of claim 23, further comprising:
computer program codes to cause the computer device to determine whether a next single-threaded kernel work is resource intensive;
computer program codes to cause the computer device to store information corresponding to the next single-threaded kernel work in a single-threaded kernel work queue if it is determined that the next single-threaded kernel work is resource intensive.

26. The method of claim 25, further comprising computer program codes to cause the computer device to execute the next single-threaded kernel work atomically provided the next single-threaded kernel work is not resource intensive.

27. The computer program product of claim 23, further comprising computer program codes to cause the computer device to handle one or more interrupts when the single-threaded kernel work. is suspended.

28. The computer program product of claim 23, wherein the one or more processes comprise one or more user processes
